(19) United States
(12) Patent Application Publication
(10) Pub. No.: US 2016/0018212 A1
(43) Pub. Date: Jan. 21, 2016

(54) METHOD AND SYSTEM FOR AUTOMATICALLY DETERMINING VALUES OF THE INTRINSIC PARAMETERS AND EXTRINSIC PARAMETERS OF A CAMERA PLACED AT THE EDGE OF A ROADWAY

(71) Applicant: MORPHO, ISSY-LES-MOULINEAUX (FR)

(72) Inventors: Alain ROUH, ISSY-LES-MOULINEAUX (FR); Jean BEAUDET, ISSY-LES-MOULINEAUX (FR); Laurent ROSTAING, ISSY-LES-MOULINEAUX (FR)

(21) Appl. No.: 14/798,850

(22) Filed: Jul. 14, 2015

(30) Foreign Application Priority Data
Jul. 15, 2014 (FR) 14/56767

(51) Int. Cl. G01B 11/00; H04N 7/18; G06T 7/00; G01B 11/14; G06T 7/60; G06K 9/52; G06T 3/00; G06K 9/62; G08G 1/04; G06T 7/20

(52) U.S. Cl. CPC G01B 11/002; G08G 1/04; H04N 7/18; G06T 7/004; G06T 7/20; G06T 7/60; G06K 9/52; G06T 3/00; G06K 9/6202; G01B 11/14; G06T 2207/30252; G06T 2207/30244

(57) ABSTRACT

A method for determining values of the intrinsic and extrinsic parameters of a camera placed at the edge of a roadway, wherein the method includes: a step of detecting a vehicle passing in front of the camera; a step of determining, from at least one 2D image taken by the camera of the vehicle detected and at least one predetermined 3D vehicle model, the intrinsic and extrinsic parameters of the camera with respect to the reference frame of the predetermined 3D vehicle model or models so that a projection of said or one of said predetermined 3D vehicle models corresponds to said or one of the 2D images actually taken by said camera. A method for determining at least one physical quantity related to the positioning of said camera with respect to said roadway. It concerns systems designed to implement methods. Finally, it concerns computer programs for implementing said methods.

The present invention relates to a method for automatic determination of values of intrinsic parameters and extrinsic parameters of a camera placed at the edge of a roadway. It also relates to a method for determining at least a physical quantity related to the positioning of said camera with respect to said roadway. It also relates to systems provided for implementing said methods. Finally, it relates to computer programs for implementing said methods.

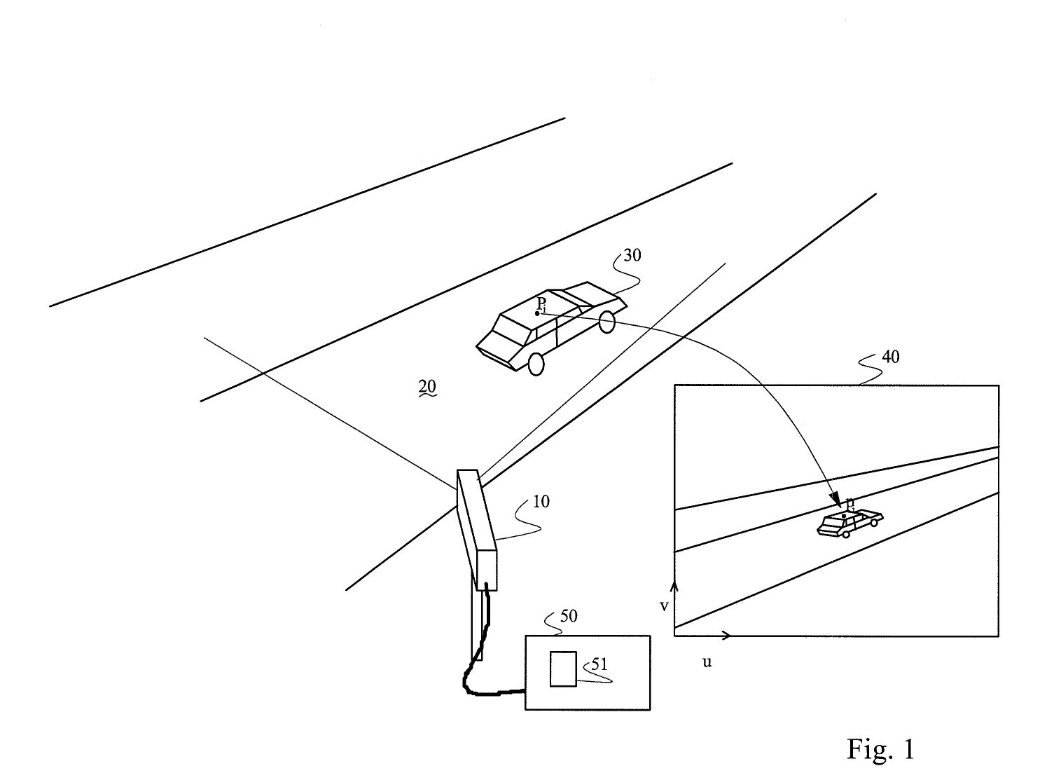

FIG. 1 depicts a camera 10 placed at the edge of a roadway 20 on which a car 30 is travelling, passing in front of the camera 10. The road 20 and the car 30 constitute a scene. The 2D image 40 that is taken by the camera 10 at a given instant is shown on the right of this FIG. 1. Throughout the following description, the camera 10 is considered to be isolated, but it will be understood that, according to the invention, it could form part of an imaging system with several cameras, for example two cameras then forming a stereoscopic imaging system.

A simplified model very widely used in the present technical field, of such a camera such as the camera 10 considers it to be a pinhole allowing a so-called perspective projection of the points Pi of the vehicle 30 on the image plane 40. Thus the equation that links the coordinates (x, y, z) of a point Pi on the vehicle 30 and the coordinates (u, v) of the corresponding point pi on the 2D image 40 can be written, in so-called homogeneous coordinates:

$$λ \cdot ( \begin{matrix}u \\ v \\ 1\end{matrix} ) = [ M ] ( \begin{matrix}x \\ y \\ z \\ 1\end{matrix} ) = K [ R T ] ( \begin{matrix}x \\ y \\ z \\ 1\end{matrix} )$$

25

where λ is an arbitrary scalar.

The matrix [M] is a 3×4 perspective projection matrix that can be decomposed into a 3×4 positioning matrix [R T] and a 3×3 calibration matrix [K]. The calibration matrix [K] is defined by the focal distances αᵤ and αᵥ of the camera in terms of dimension of pixels along the axes u and v of the image 40 as well as by the coordinates u₀ and v₀ of the origin of the 2D image 40:

$$[ K ] = [ \begin{matrix}{α}_{u} & & {u}_{0} \\ & {α}_{v} & {v}_{0} \\ & & 1\end{matrix} ]$$

The positioning matrix [R T] is composed of a 3×3 rotation matrix and a 3-dimensional translation vector T that define, through their respective components, the positioning (distance, orientation) of the reference frame of the scene with respect to the camera 10.

For more information on the model that has just been described, reference can be made to the book entitled “Multiple View Geometry in Computer Vision” by R. Hartley and A. Zisserman, published by Cambridge University Press, and in particular to chapter 6 of this book.

In general terms, the coefficients of the calibration matrix [K] are intrinsic parameters of the camera concerned whereas those of the positioning matrix [R T] are extrinsic parameters.

Thus, in the patent application US 2010/0283856, a vehicle is used to calibrate a camera, the calibration in question being the determination of the projection matrix [M]. The vehicle in question has markers, the relative positions of which are known. When the vehicle passes in front of the camera, a 2D image is taken at a first point and another 2D image at a second point. The images of the markers in each of the 2D images are used to calculate the projection matrix [M].

The aim of the present invention is to propose a method for automatic determination of the values of intrinsic parameters and extrinsic parameters of a camera placed at the edge of a roadway. “Automatic determination” means the fact that the system is capable of determining the values of all or some of the parameters of the projection matrix [M] without implementing any particular measurement procedure and/or use of a vehicle carrying markers, such as the one that is used by the system of the patent US 2010/0283856, solely by implementing this automatic determination method.

To this end, the present invention relates to a method for automatic determination of the values of intrinsic parameters and extrinsic parameters of a camera placed at the edge of a roadway, which is characterised in that it comprises:
a step of detecting a vehicle passing in front of the camera,
a step of determining, from at least one 2D image taken by the camera of the vehicle detected and at least one predetermined 3D vehicle model, intrinsic and extrinsic parameters of a camera with respect to the reference frame of the predetermined 3D vehicle models so that a projection of said or of one of said predetermined vehicle models corresponds to said or one of the 2D images actually taken by said camera.

The present invention also relates to a method for determining at least one physical quantity related to the positioning of a camera placed at the edge of a roadway. This method is characterised in that it comprises:
a step of determining values of intrinsic parameters and extrinsic parameters of said camera by implementing automatic determination method that has just been described,
a step of establishing, from said parameter values, the positioning matrix of the camera,
a step of calculating the matrix of the inverse transformation, and
a step of deducing, from said positioning matrix and the inverse transformation matrix, the or each of said physical quantities, each physical quantity being one of the following quantities:
the height of the camera with respect to the road,
the distance of said camera with respect to the recognised vehicle,
the direction of the road with respect to the camera,
the equation of the road with respect to the camera.

The present invention also relates to a system for automatic determination of values of intrinsic parameters and extrinsic parameters of a camera placed at the edge of a roadway, which is characterised in that it comprises:
means for detecting a vehicle passing in front of the camera,
means for determining, from at least one 2D image taken by the camera of the vehicle detected and at least one predetermined 3D vehicle model, intrinsic and extrinsic parameters of a camera with respect to the reference frame of the predetermined 3D vehicle models so that a projection of said or of one of said predetermined vehicle models corresponds to said or one of the 2D images actually taken by said camera.

Finally, it relates to computer programs for implementing the methods that have just been described.

The features of the invention mentioned above, as well as others, will emerge more clearly from a reading of the following description of example embodiments, said description being given in relation to the accompanying drawings, among which:

FIG. 1 is a view of a scene of a vehicle passing in front of a camera connected to an image processing system for implementing the method of the invention,

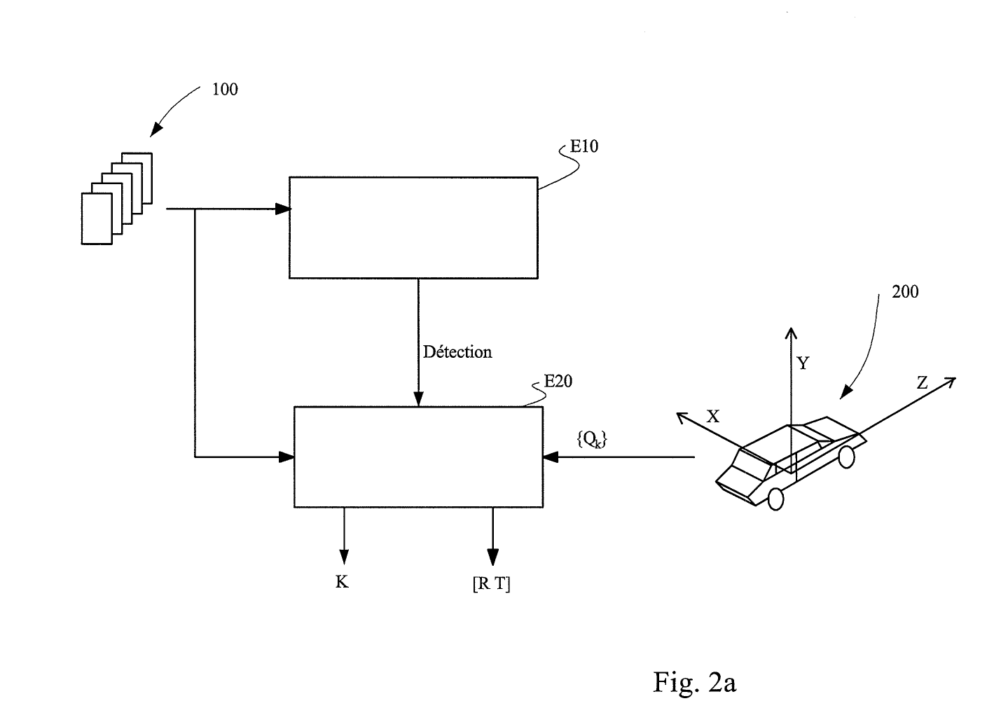

FIG. 2a is a diagram illustrating the method for automatically determining absolute values of intrinsic parameters and extrinsic parameters of a camera according to a first embodiment of the invention,

FIG. 2b is a diagram illustrating a method for automatically determining absolute values of intrinsic parameters and extrinsic parameters of a camera according to a second embodiment of the invention,

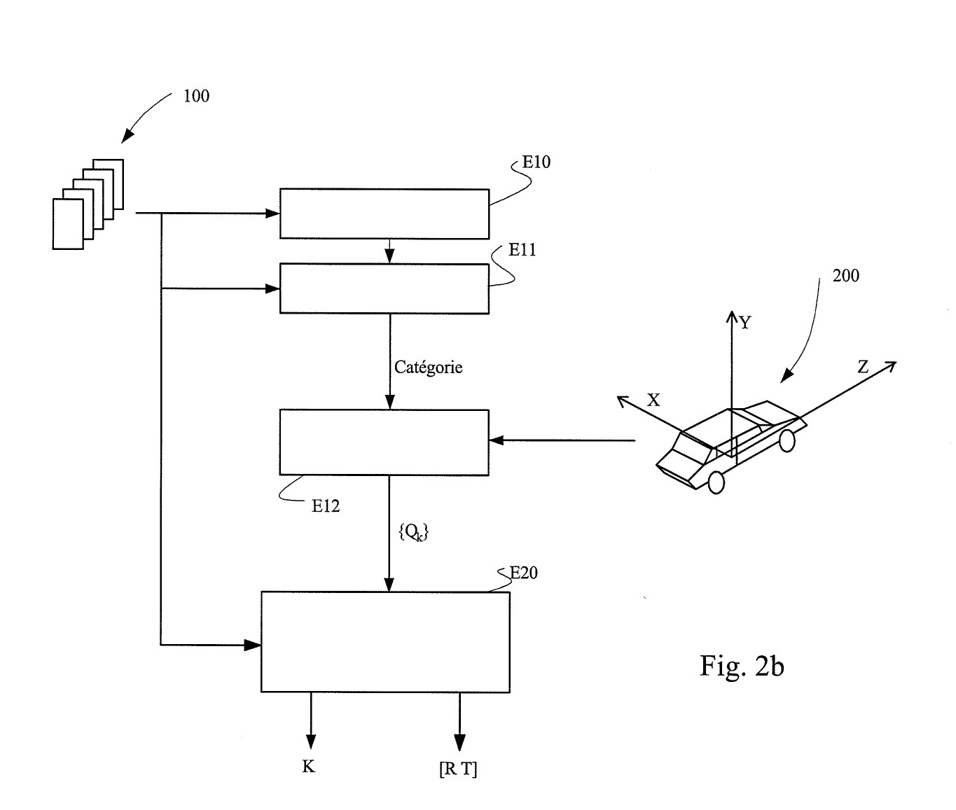

FIG. 3 is a diagram illustrating a step of the automatic determination method of the invention according to a first embodiment,

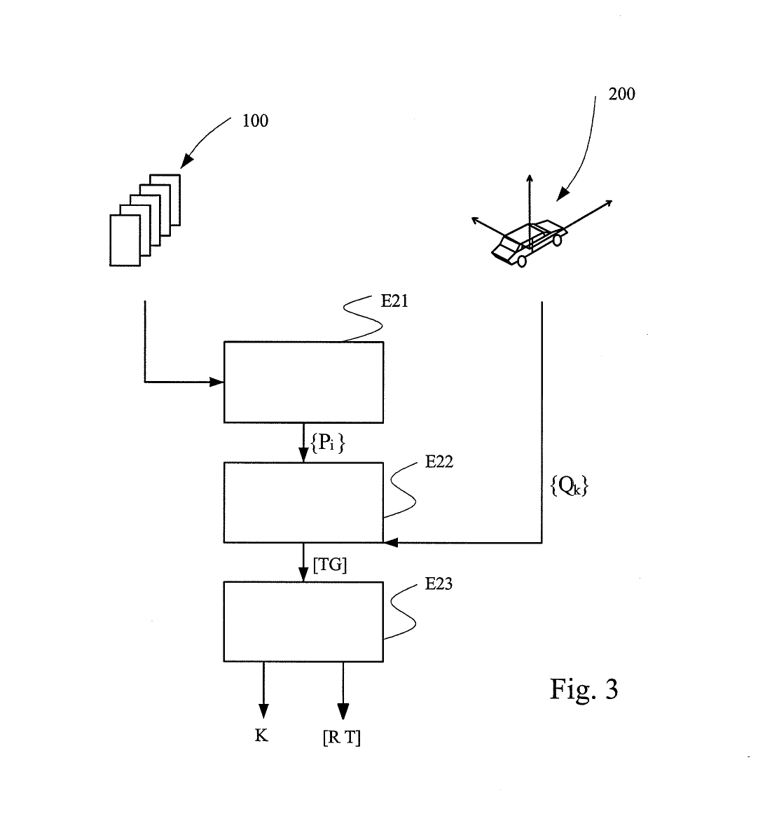

FIG. 4 is a diagram illustrating the same step of the automatic determination method of the invention according to a second embodiment.

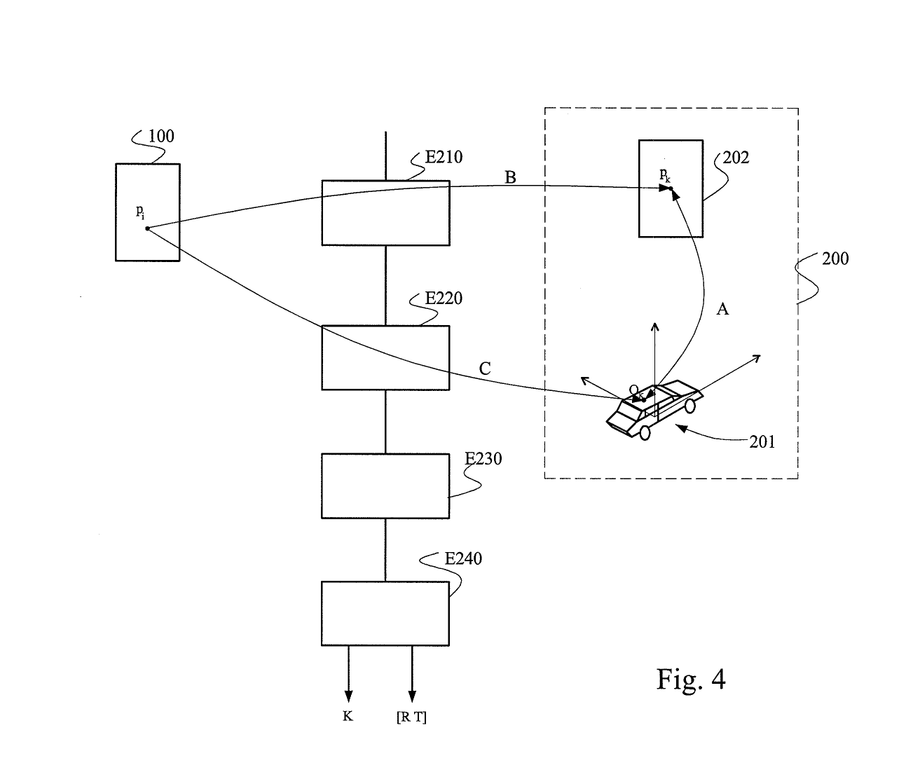

FIG. 5 is a diagram illustrating a method for determining at least a physical quantity related to the positioning of a camera with respect to the roadway, and

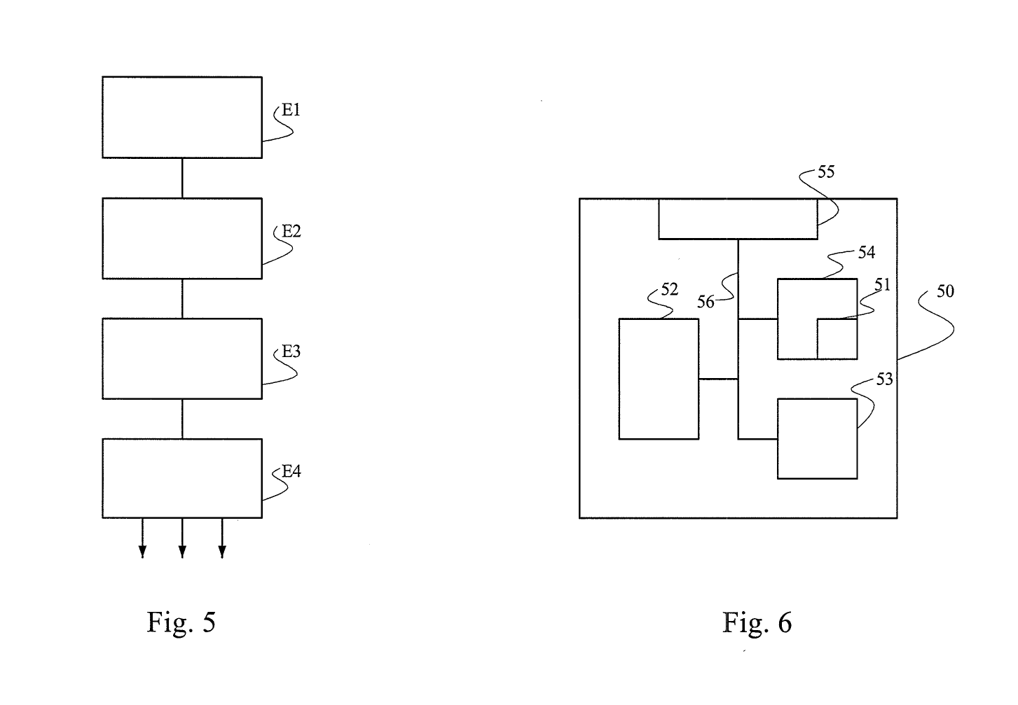

FIG. 6 is a block diagram of an image processing system for implementing the method of the invention.

The method for the automatic determination of the intrinsic and extrinsic parameters of a camera 10 (see FIG. 1) of the present invention is implemented in an image processing unit 50 designed to receive the 2D images, taken by the camera 10, of a vehicle 30 travelling on a roadway 20.

In a first embodiment of the invention depicted in FIG. 2a, the first step E10 is a step of detecting a vehicle 30 passing in front of the camera 10. For example, this detection is carried out using an image taken by the camera 10 or images in a sequence of 2D images 100 taken by the camera 10, the detection then being supplemented by a tracking process. A process such as the one that is described for detecting number plates in the thesis by Louka Dlagnekov at the University of California San Diego, entitled “Video-based Car Surveillance: License Plate, Make and Model Recognition” and published in 2005, can thus be used for this step E10.

A second step E20 is a step of determination, by using at least one 2D image 100 of the vehicle detected at step E10 taken by the camera 10, and by using at least one predetermined 3D vehicle model 200 from a set of predetermined 3D vehicle models of different categories (for example of different models of vehicle of different makes), of the intrinsic and extrinsic parameters of the camera 10 with respect to the reference frame of the predetermined 3D vehicle model or models 200 so that a projection by the camera 10 of said or one of said predetermined 3D vehicle models 200 corresponds to said or one of the 2D images 100 actually taken by said camera 10.

According to the terminology of the present description, a predetermined 3D vehicle model is a set of points Qk of coordinates (x, y, z) in a particular reference, referred to as the reference frame. For example, the X-axis of this reference frame is a transverse axis of the vehicle, the Y-axis is the vertical axis of the vehicle and the depth axis Z is the longitudinal axis of the vehicle. As for the origin 0 of this reference frame, it is for example the projection along the Y-axis of the barycentre of said vehicle on a plane parallel to the plane (X, Z) and tangent to the bottom part of the wheels of the vehicle normally in contact with the ground. The or each predetermined 3D vehicle model is for example stored in a database 51 of the unit 50, shown in FIG. 1.

In order to limit the number of predetermined 3D vehicle models to be used at step E20, a second embodiment depicted in FIG. 2b of the automatic determination method also comprises:
a step E11 of recognising, from a 2D image or at least one image in a sequence of 2D images taken by the camera 10, at least one vehicle characteristic of the vehicle detected at the detection step E10, and
a step E12 of associating, with said or some vehicle characteristics recognised at step E11, at least one predetermined 3D vehicle model 200.

The predetermined 3D vehicle model or models {Qk} that are considered at the determination step E20 are then the predetermined vehicle model or models that were associated, at step E12, with the vehicle characteristic or characteristics recognised at step E11.

The vehicle characteristic in question here may be related to a particular vehicle (the vehicle registered xxxx), with a particular vehicle model (the vehicle brand “Simca Plein Ciel”), or a set of vehicle models (vehicles of brand Peugeot®, all models taken together).

The vehicle characteristic or characteristics that can be used, are for example, SIFT (Scale invariant feature transform) characteristics presented in the article by David G. Lowe entitled “Distinctive Image Features From Scale-Invariant Keypoints” published in International Journal of Computer Vision 60.2 (2004) p 91-110, SURF (Speed Up Robust Features) characteristics presented in the document by Herbert Bay, Tinne Tuytelaars and Luc Van Gool entitled <<SURF: Speeded Up Robust Features>> and published in 9th European Conference on Computer Vision, Graz, Austria, 7-13 May 2006, shape descriptors, etc. These characteristics may also be linked to the appearance of the vehicle (so-called Eigenface or Eigencar vectors).

Thus step E11 of the method of the invention can implement a method that is generally referred to as a “Make and Model Recognition Method”. For information on the implementation of this method, it is possible to refer to the thesis by Louka Dlagnekov already mentioned above.

The characteristic in question may also be a characteristic that unequivocally identifies a particular vehicle, for example a registration number on the number plate of this vehicle. Step E11 consists of recognising this registration number. The thesis by Louka Dlagnekov already mentioned also describes number plate recognition methods.

Two embodiments are envisaged for implementing step E20 of the automatic determination of the invention described above in relation to FIGS. 2a and 2b. The first of these embodiments is now described in relation to FIG. 3.

In a first substep E21, a 3D model of said vehicle 30 is established from at least two 2D images 100 in a sequence of 2D images taken by the camera 10 at different instants t0 to to while the vehicle 30 detected at step E10 passes in front of the camera 10,. The 3D model in question is a model that corresponds to the vehicle 30 that is actually situated in front of the camera 10, unlike the predetermined 3D vehicle model. Such a 3D model of the vehicle 30 is a set of points Pi of coordinates taken in a reference frame related to the camera which, projected by the camera 10 at an arbitrary time, for example at time t0, form a set of points pi0 in a 2D image, denoted I0, formed by the camera 10. At a time tj, the vehicle has moved with respect to time t0 but for the camera 10 it has undergone a matrix rotation [Rj] and a vector translation Tj. Thus a point Pi on the vehicle detected is, at a time tj, projected by the camera 10 at a projection point \tilde{p}ᵢⱼ of the image Ij, such that:

\tilde{p}ᵢⱼ=K[Rⱼ Tⱼ]Pᵢ

where K is a calibration matrix and [Rj Tj] is a positioning matrix.

By convention, the position of the vehicle is considered with respect to the camera at the time t0 of taking the first image in the sequence of 2D images as being the reference position so that the positioning matrix at this time t0 is then the matrix [I 0].

Next a so-called bundle adjustment method is implemented—see for example the article by Bill Triggs et al entitled “Bundle adjustment—a modern synthesis”, published in Vision Algorithms: Theory & Practice, Springer Berlin Heidelberg, 2000, pages 298 to 372, which consists of considering several points Pi of different coordinates and, from there, changing the values of the parameters of the calibration matrices [K] and positioning matrix [Rⱼ Tⱼ₁], and, for each set of values or parameters and coordinates of points Pi, first of all determining by means of the above equation the projected points \tilde{p}ᵢⱼ and then comparing them with the points pᵢⱼ actually observed on an image Ij and retaining only the points Pi and the values of parameters of the positioning matrix [Rj Tj] and of the calibration matrix [K] that maximise the matching between the points \tilde{p}ᵢⱼ and the points pᵢⱼ, that is to say those that minimise the distances between these points. The following can therefore be written:

$${( {P}_{i} , \{ {R}_{j} {T}_{j} ] K )}_{optimisation} = argmin ( {\sum }_{i , j} {‖ {\tilde{p}}_{ij} - {p}_{ij} ‖}^{2} )$$

This equation can be solved by means of a Levenberg-Marquardt non-linear least squares optimisation algorithm.

Advantageously, the bundle adjustment method is used after a phase of initialisation of the intrinsic and extrinsic parameters and of the coordinates of the points Pi of the 3D model of the vehicle detected, in order to prevent its converging towards a sub-optimum solution while limiting the consumption of computing resources.

The intrinsic parameters of the camera may for example be initialised by means of the information contained in its technical file or obtained empirically, such as its ratio between focal length and pixel size for each of the axes of its sensor. Likewise, the main point may be considered to be at the centre of the 2D image. The values contained in this information, without being precise, are suitable approximations.

For initialising the extrinsic parameters, it is possible to proceed as follows. First of all, from a certain number of matches established between points pij of the image Ij and points pi0 of the first image I0, a so-called essential matrix E is determined that satisfies the following equation:

(K⁻¹pᵢⱼ)^{T}E(K⁻¹pᵢ₀)=0

For more information on this process, reference can be made to the book entitled “Multiple View Geometry in Computer Vision” by R. Hartley and A. Zisserman, published by Cambridge University Press and in particular chapter 11.7.3.

Next, from this essential matrix E, the matrices [Rⱼ Tⱼ] are calculated for the various times tj. For more information on this process, reference can be made to chapter 9.6.2 of the same book mentioned above.

Finally, for initialising the 3D coordinates of the points Pi, it is possible to use pairs of images Ij and Ij′ and matches of points pij and pij′ in these pairs of images. The intrinsic and extrinsic parameters of the camera considered here are the parameters estimated above for initialisation purposes. For more information on this process, reference can be made to chapter 10 of the book mentioned above.

At the end of this first substep E21, a 3D model of the vehicle detected is available, defined to within a scale factor and non-aligned, that is to say of a set of points Pi of this vehicle when it is situated in the reference position mentioned above (position at time t0).

In a second substep E22, the 3D model of the vehicle detected is aligned with at least one predetermined 3D vehicle model {Qk}. In the second embodiment envisaged above in relation to FIG. 2b, the predetermined 3D vehicle model or models considered here are those that were, at step E12, associated with the vehicle characteristic or characteristics recognised at step E11.

For this alignment, the parameters are sought of a geometric matrix transformation [TG] which, applied to the set or each set of points Qk of the or each predetermined 3D vehicle model, makes it possible to find the set of points Pi forming the 3D model of the detected vehicle.

The matrix [TG] can be decomposed into a scale change matrix [S_{M}] and an alignment matrix [R_{M} T_{M}] where R_{M} is a rotation matrix and T_{M} is a translation vector. The scale change matrix [S_{M}] is a 4×4 matrix that can be written under the form:

$$[ {S}_{M} ] = ⌊ \begin{matrix}{I}_{3} & 0 \\ 0 & {s}_{M}\end{matrix} ⌋$$

where s_{M} is a scale ratio.

If a second camera that is calibrated with respect to the first camera 10 is available (it should be noted that, in this case, because cameras calibrated with each other are considered, only the extrinsic parameters of the camera 10 with respect to the road are sought), it is possible to establish, from a single pair of images, by standard stereoscopy method, a model of the detected vehicles such that s_{M} is equal to 1.

On the other hand, if such a second camera calibrated with respect to the first camera 10 is not available, it is possible to proceed as follows. For a certain number of values of the scale ratio s_{M}, the alignment matrix [R_{M} T_{M}] is determined. To do this, it is possible to use the ICP (iterative closest point) algorithm that is described by Paul J. Besl and Neil D. McKay in an article entitled “Method for registration of 3-D shapes” that appeared in 1992 in “Robotics-DL Tentative”, International Society for Optics and Photonics.

For each value of the scale ration s_{M}, an alignment score s with a good match is established, for example equal to the number of points Pi that are situated at no more than a distance d from points Pk such that:

∥PᵢPₖ∥<d with

Pₖ=S_{M}[R_{M} T_{M}]Qₖ

Next the scale ratio value s_{M} and the corresponding values of the parameters of the alignment matrix [R_{M} T_{M}] that have obtained the best alignment score s are selected. This is the best alignment score s.

If several predetermined 3D vehicle models are available, as before for a single predetermined 3D vehicle model, the best alignment score s is determined this time for each predetermined 3D vehicle model and then the predetermined 3D vehicle model that obtained the best score on best alignment is adopted. The predetermined 3D vehicle model adopted corresponds to a vehicle model that can in this way be recognised.

In a third substep E23, the extrinsic parameters of the camera with respect to the reference frame of the predetermined 3D vehicle model of the vehicle recognised are determined. To do this the following procedure is followed.

For each point pk0 of the 2D image I0 delivered by the camera 10 at time t0, there is a corresponding point Qₖ in the predetermined 3D vehicle model, so that the following can be written:

pk0=KS_{M}[R_{M} T_{M}]Qₖ=K[R_{M} T_{M}]Qₖ

Thus the matrix of extrinsic parameters of the camera relative to the predetermined 3D vehicle model of the vehicle recognised is the matrix:

[R T]=[R_{M} T_{M}]

A description is now given in relation to FIG. 4 of a second embodiment envisaged for implementation of step E20 mentioned above in relation to FIGS. 2a and 2b.

For this embodiment, each predetermined 3D vehicle model 200 in said set of predetermined 3D vehicle models for example stored in the database 51 consist not only of a proper predetermined 3D vehicle model 201, that is to say a set of points Qk, but also points pk of at least one 2D reference image 202 obtained by projection, by a reference camera, real or virtual, of the points Qk of the predetermined 3D vehicle model 201. Thus, for each predetermined 3D vehicle model 200, the points pk of the or each reference image 202 match points Qk of said predetermined 3D vehicle model proper 201 (see arrow A).

There is also available a 2D image 100 actually taken by the camera 10 of the vehicle 30 detected at step E10 of the method of the invention (see FIGS. 2a and 2b).

In a first substep E210, matches between points pi of the 2D image 100 of the vehicle 30 detected and points pk of the image or of a reference 2D image 202 (arrow B) are first of all established and then, in a second substep E220, matches between points pi of the 2D image 100 of the vehicle 30 detected and points Qk of the predetermined 3D vehicle model proper 201 considered (arrow C). As before, in the second embodiment envisaged above in FIG. 2b, the predetermined 3D model or models considered here are those with which, at step E12, the vehicle characteristic or characteristics that were recognised at step E11 were associated.

It is considered that each point pi of the 2D image 100 is the result of a transformation of a point Qk of the proper predetermined 3D vehicle model 201 of the vehicle 30 detected. This transformation can be assimilated to a projection made by the camera 10, an operation hereinafter referred to as “pseudo-projection”, and it is thus possible to write:

$${λ}_{i} \cdot ⌊ \begin{matrix}{p}_{i} \\ 1\end{matrix} ⌋ = [ A ] {Q}_{k}$$

where [A] is a 3×4 matrix then said to be pseudo-projection.

If a sufficient number of matches are available (generally at least 6 matches), this equation represents an overdetermined linear system, that is to say where it is possible to determine the coefficients of the pseudo-projection matrix [A]. This calculation of the matrix [A], carried out at step E230, is for example described in chapter 7.1 of the book mentioned above. At the following step E240, the intrinsic and extrinsic parameters of said camera are deduced from the parameters thus determined of said pseudo-projection matrix [A].

The pseudo-projection matrix [A] can be written in the following factorised form:

[A]=K [R T]=[K[R]KT]

where [R] is the matrix of the rotation of the camera 10 with respect to the predetermined 3D vehicle model of the recognised vehicle and T the translation vector of the camera with respect to the same predetermined 3D vehicle model.

The 3×3 submatrix to the left of the pseudo-projection matrix [A] is denoted [B].

This gives:

[B]=K[R].

The following can be written:

[B][B]^{T}=K[R](K[R])^{T}=K[R][R]^{T}K^{T}=KK^{T}

If it is assumed that the calibration matrix K is written under the form of the above equation (2), it is possible to write, by developing KK^{T}:

$${KK}^{T} = ⌊ \begin{matrix}{α}_{u}^{2} + {u}_{0}^{2} & {u}_{0} {v}_{0} & {u}_{0} \\ {u}_{0} {v}_{0} & {α}_{v}^{2} + {v}_{0}^{2} & {v}_{0} \\ {u}_{0} & {v}_{0} & 1\end{matrix} ⌋$$

The product [B][13]^{T} can be written under the form of these coefficients:

[B][B]^{T}=[bᵢⱼ] with i, j=1 to 3.

From knowledge of [B][B]^{T}=λ KK^{T} obtained from the matrix [A], it is possible to calculate λ (the parameter λ is then equal to b₃₃) and the coefficients of the calibration matrix K, and then the parameters of the matrix [R T]=K⁻¹ [A].

Whereas the first embodiment (see FIG. 3) requires a sequence of at least two images, the second embodiment (FIG. 4) requires only one image but a more elaborate predetermined 3D vehicle model since it is associated with a reference 2D image.

Once the intrinsic and extrinsic parameters of the camera have been determined with respect to the reference frame of the predetermined 3D vehicle models (the reference frame is identical for all the 3D models) stored in the database 51, and thus when a vehicle 30 having remarkable characteristics that can be recognised at step E11 passes in front of the camera 10, it is possible to determine a certain number of physical quantities.

Thus the present invention concerns a method for determining at least a physical quantity related to the positioning of a camera placed at the edge of a roadway. It comprises (see FIG. 5) a step E1 of determining the values of the intrinsic parameters and the extrinsic parameters of said camera 10 by implementing the automatic determination method that has just been described.

It also comprises a step E2 of establishing, from said parameter values, the positioning matrix of the camera [R T] and then, at a step E3, of calculating the matrix [R′ T′] of the inverse transformation.

Finally, it comprises a step E4 of deducing, from said positioning matrix [R T] and the inverse transformation matrix [R′ T′], the or each of said physical quantities in the following manner:

the height h with respect to the road: h=T′_{z}.
the lateral distance of the camera with respect to the vehicle recognised: d =Tₓ,
the direction of the road with respect to the camera: 3^{rd} column of the matrix R,
the equation of the plane of the road with respect to the camera:

$${[ \begin{matrix}{2}^{nd} column of matrix R \\ - {T}_{y}\end{matrix} ]}^{T} \cdot [ \begin{matrix}x \\ y \\ z \\ 1\end{matrix} ] = 0$$

Two quantities remain unknown :
the longitudinal position with respect to the road. It can nevertheless be established by means of references along the road, of the milepost type, and
the lateral position with respect to the road (for example the distance to the centre of the closest lane). It is possible to determine it not from the passage of a single vehicle but from passages of several vehicles. Thus, for each vehicle, the lateral distance of this vehicle is calculated and the shortest lateral distance is selected as being the distance to the centre of the closest lane of the road. Statistical analyses of the lateral distance between the camera and the vehicles passing in front of it, can be made in order to estimate the calibration of the lanes with respect to the camera. Next it is possible to determine, for each vehicle passing in front of the camera, the number of the lane on which it is situated.

FIG. 6 shows a processing system 50 that is provided with a processing unit 52, a program memory 53, a data memory 54 including in particular the database 51 in which the predetermined 3D vehicle models are stored, and an interface 55 for connecting the camera 10, all connected together by a bus 56. The program memory 53 contains a computer program which, when running, implements the steps of the methods that are described above. Thus the processing system 50 contains means for acting according to these steps. According to circumstances, it constitutes either a system for automatically determining the values of the intrinsic parameters and extrinsic parameters of a camera placed at the edge of a roadway, or a system for determining at least one physical quantity related to the positioning of a camera placed at the edge of a roadway.

1. Method for automatically determining intrinsic parameters and extrinsic parameters of a camera placed at the edge of roadway, wherein the method comprises:
a step E10 of detecting a vehicle passing in front of the camera,
a step E20 of determining, from at least one 2D image taken by the camera of the vehicle detected and at least one predetermined 3D vehicle model, intrinsic and extrinsic parameters of the camera with respect to the reference frame of the predetermined 3D vehicle model or models so that a projection of said or one of said predetermined 3D vehicle models corresponds to said or one of the 2D images actually taken by said camera.

2. Automatic determination method according to claim 1, wherein the method also comprises:
a step E11 of recognising, from a 2D image or at least one image in the sequence of 2D images, at least one vehicle characteristic of a vehicle detected at step E10,
a step E12 of associating, with the or said vehicle characteristic or characteristics recognised at step E11, at least one predetermined 3D vehicle model from a predetermined set of predetermined 3D vehicle models of different categories of vehicle, and
in that the predetermined 3D vehicle model or models that are considered at the determination step E20 are at least a predetermined 3D vehicle model that, at step E12, was associated with the characteristic or characteristics recognised at step E11.

3. Automatic determination method according to claim 1, wherein the determination step comprises:
a substep E21 of establishing, from at least two 2D images in said sequence of images, a 3D model of the vehicle detected at step E10,
a substep E22 of aligning the predetermined 3D vehicle model or models considered with the 3D model of the vehicle recognised, in order to determine the parameters of a geometric transformation which, applied to the predetermined 3D vehicle model or models, gives the 3D model of the vehicle recognised,
a substep E23 of deducing, from the parameters of said transformation, intrinsic and extrinsic parameters of said camera.

4. Automatic determination method according to claim 3, wherein the alignment substep E22 consists of determining the parameters of said geometric transformation for various scale ratio values, establishing an alignment score for each scale ratio value and selecting the scale ratio value and the parameters of said alignment transformation that have obtained the best alignment score.

5. Automatic determination method according to claim 3, wherein the alignment substep E22 consists of determining, for each predetermined 3D vehicle model considered, the parameters of said geometric transformation for various scale ratio values, establishing an alignment score for each scale ratio value and selecting the scale ratio value and the parameters of said alignment transformation that have obtained the best alignment score, referred to as the best-alignment score, and then selecting the predetermined 3D vehicle model, the scale ratio value and the parameters of said alignment transformation that have obtained the best score of best alignment.

6. Automatic determination method according to claim 1, wherein each predetermined 3D vehicle model consists of:
the predetermined 3D model proper, and
points of at least one reference 2D image obtained by projection, by a camera, real or virtual, of points on said predetermined 3D vehicle model considered, and in that said method comprises:
a substep E210 of associating points on the reference 2D image of said predetermined 3D vehicle model considered with points on a 2D image taken by the camera,
a substep E220 of associating points on the predetermined 3D vehicle model proper with said points on the 2D image taken by the camera,
a substep E230 of determining the parameters of a pseudo-projection transformation which, applied to points on said 3D model proper, gives points on the 2D image taken by the camera,
a substep E240 of deducing, from the parameters of said pseudo-projection transformation, intrinsic and extrinsic parameters of said camera.

7. Method for determining at least a physical quantity related to the positioning of a camera placed at the edge of a roadway, wherein the method comprises:
a step of determining the values of the intrinsic parameters and extrinsic parameters of said camera by implementing the automatic determination method according to claim 1,
a step of establishing, from said parameter values, the positioning matrix of the camera,
a step of calculating the matrix of the inverse transformation, and
a step of deducing, from said positioning matrix and the inverse transformation matrix, the or each of said physical quantities,
each physical quantity being one of the following quantities:
the height of the camera with respect to the road,
the distance of said camera with respect to the vehicle recognised,
the direction of the road with respect to the camera,
the equation of the road with respect to the camera.

8. Method for determining at least a physical quantity according to claim 7, wherein the physical quantity or quantities comprise the lateral position of the camera with respect to the road, determined from passages of several vehicles, by calculating the lateral distance to each vehicle and selecting the shortest lateral distance.

9. System for automatically determining the values of the intrinsic parameters and the extrinsic parameters of a camera placed at the edge of a roadway, wherein the system comprises:
means for detecting a vehicle passing in front of the camera,
means for determining, from at least one 2D image taken by the camera of the vehicle detected and at least one predetermined 3D vehicle model, the intrinsic and extrinsic parameters of a camera with respect to the reference frame of the predetermined 3D vehicle models so that a projection of said or of one of said predetermined vehicle models corresponds to said or one of the 2D images actually taken by said camera.

10. Automatic determination system according to claim 9, wherein the system also comprises:
means for recognising, from a 2D image or at least one image in the sequence of 2D images, at least one vehicle characteristic of a vehicle passing in front of the camera,
means for associating, with said recognised vehicle characteristic or characteristics of the vehicle detected, at least one predetermined 3D vehicle model from a predetermined set of predetermined 3D vehicle models of different categories of vehicle, and
in that the predetermined 3D vehicle model or models that are considered are at least a predetermined 3D vehicle model that was associated with the characteristic or characteristics recognised.

11. System for determining at least a physical quantity related to the positioning of a camera placed at the edge of a roadway, wherein the system comprises:
means for determining the values of the intrinsic parameters and extrinsic parameters of said camera by implementing the automatic determination method according to claim 1,
means for establishing, from said parameter values, the positioning matrix of the camera,
means for calculating the matrix of the inverse transformation, and
means for deducing, from said positioning matrix and/or the inverse transformation matrix, the or each of said physical quantities,
each physical quantity being one of the following quantities:
the height of the camera with respect to the road,
the distance of said camera with respect to the vehicle recognised,
the direction of the road with respect to the camera,
the equation of the road with respect to the camera.

12. A non-transitory computer readable medium embodying a computer program to automatically determine the values of the intrinsic parameters and the extrinsic parameters of a camera placed at the edge of a roadway , wherein the computer program is designed, when it is executed on a computing system, to implement the automatic determination method according to claim 1.

13. A non-transitory computer readable medium embodying a computer program to determine at least a physical quantity related to the positioning of a camera placed at the edge of a roadway, wherein the computer program is designed, when it is executed on a computing system, to implement the method for determining at least on physical quantity according to claim 7.
